(19) United States
(12) Patent Application Publication
(10) Pub. No.: US 2020/0327539 A1
(43) Pub. Date: Oct. 15, 2020

(54) SYSTEMS AND METHODS FOR USE IN FACILITATING NETWORK TRANSACTIONS

(71) Applicant: MASTERCARD INTERNATIONAL INCORPORATED, PURCHASE, NY (US)

(72) Inventors: Erick Andrew, New York, NY (US); Issidor L. Iliev, White Plains, NY (US)

(21) Appl. No.: 16/383,201

(22) Filed: Apr. 12, 2019

(51) Int. Cl. G06Q 20/38; G06Q 20/42; G06Q 20/02

(52) U.S. Cl. CPC G06Q 20/381; G06Q 20/023; G06Q 20/425

(57) ABSTRACT

Systems and methods are provided for establishing fixed currency conversion rates for transactions in connection with authorization and clearing of the transactions. One exemplary method includes receiving a currency conversion request in association with an authorization request for a transaction, identifying a currency conversion rate (CCR) for the transaction based on a rate file stored in a data structure in association with an identifier for the transaction, determining a converted transaction amount based on a transaction amount included in the authorization request and the CCR, and passing the converted transaction amount to an authorization network. The method also includes receiving a conversion request in connection with clearing the transaction, retrieving the CCR from the data structure based on the identifier, and determining a clearing transaction amount based on the transaction amount as included in a clearing record and the CCR received from the data structure.

### FIELD

The present disclosure generally relates to systems and methods for use in facilitating network transactions.

### BACKGROUND

This section provides background information related to the present disclosure which is not necessarily prior art.

Users are known to purchase various different products (e.g., goods and services, etc.) from merchants via payment account transactions, and to withdraw cash from banks or at automated teller machines (ATMs) through the use of payment accounts. The users are also known to reside in regions, whereupon a portion of such transactions performed by the users takes place in the regions of their residence, i.e., their native or home regions (using their native currencies). In addition, the users may travel to other regions, i.e., foreign regions, whereupon payment account transactions in the foreign regions may involve different currencies (e.g., foreign currencies, etc.) and/or extra fees.

When performing payment account transactions in foreign regions, each of the transactions is often submitted (for authorization, clearing, settlement, etc.) in the currency of the region in which the merchant or ATM involved in the transaction is located and is subject to a currency conversion to the native currency of the account associated with the user performing the transaction (e.g., Euros to U.S. dollars when the merchant is located in France and the user resides in the U.S., etc.). The currency conversion is performed at one or more rates by an issuer of the user's account, which are known to fluctuate from time to time (e.g., a daily, etc.). Alternatively, the transaction may be submitted (for authorization, clearing, settlement, etc.) in the native currency of the user's account, through a dynamic currency conversion (DCC) option available to the user at the point of interaction with the merchant or ATM, where the DCC is then coordinated by the merchant, a banking institution associated with the ATM, or another entity associated with either.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in identifying currency conversion rates for converting foreign currencies to native currencies in connection with payment account transactions;

FIG. 2 is a block diagram of a computing device that may be used in the exemplary system of FIG. 1; and

FIG. 3 is an exemplary method that may be implemented in the system of FIG. 1 for providing a fixed currency conversion rate for a transaction, during authorization of the transaction, whereby the transaction is then cleared at the fixed currency conversion rate.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Users purchase products from merchants through use of payment accounts in regions in which the users reside (i.e., in their native or home regions), as well as in other regions (i.e., foreign regions or not native regions). The users may also withdraw cash from banks or at automated teller machines (ATMs) from their payment accounts in their home (or native) regions, or in foreign regions. When currencies used in the native regions (i.e., native currencies) are different from currencies used in the foreign regions (i.e., local, foreign currencies), currency conversions are often employed by payment networks involved in the transactions, or by issuers of the payment accounts used in the transactions. The rates at which the conversions are performed (i.e., the currency conversion rates) may be different at the time of authorization of the transactions than at the time of clearing the transactions, whereby the amounts of the transactions (including the currency conversion charges) may change between authorization and clearing. Such changes may create confusion and/or uncertainty for the users involved in the transactions and associated with the payment accounts used in the transactions.

Uniquely, the systems and methods herein provide for fixed currency conversion rates, whereby the currency conversion rate during authorization of the transactions is the same as the currency conversion rate at clearing of the transactions. In particular, a conversion engine is employed, which identifies a currency conversion rate applied to authorization of a transaction. The conversion engine stores the identified conversion rate in a rate file data structure (or a rate file identifier therefor), whereby the currency conversion rate (e.g., as identified by the rate file identifier, etc.) may be used for the transaction during clearing. In this manner, uncertainty regarding the amount of the transaction may be reduced and/or eliminated. What's more, when a dynamic currency conversion (DCC) is identified in the transaction messaging, the conversion engine may notify the issuer associated with the payment account to which the transaction is directed, thereby permitting the issuer to provide comparative rate information to the user. In this further manner, the user may be informed of the potential impact of opting for the DCC option, over a payment network or issuer currency conversion rate, at a point of interaction when performing the transaction.

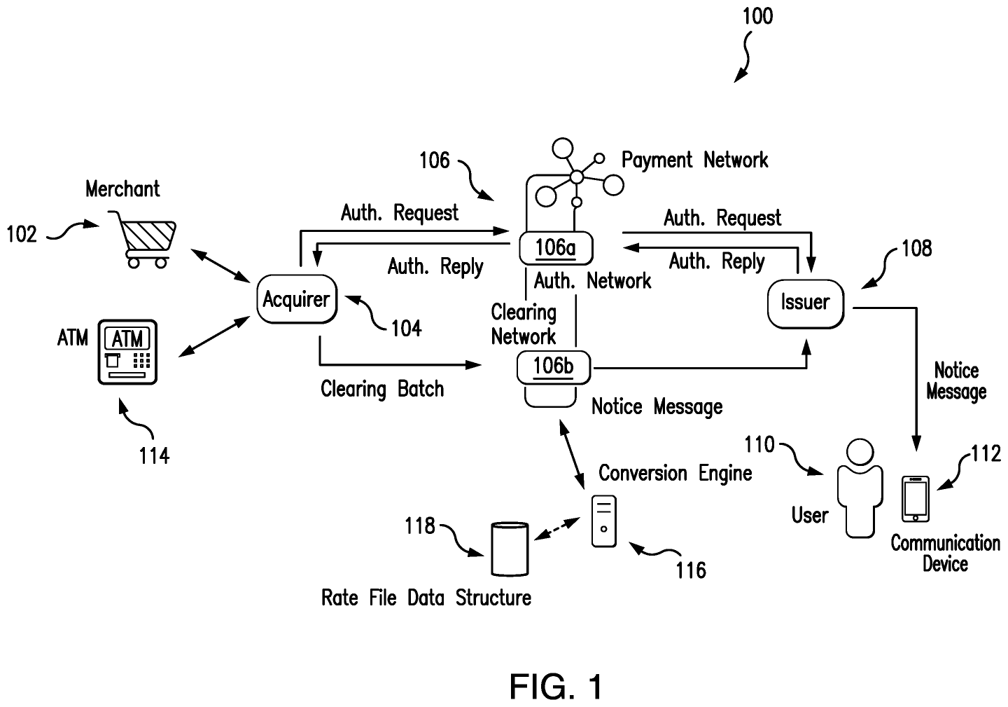

FIG. 1 illustrates an exemplary system 100 in which one or more aspects of the present disclosure may be implemented. Although the system 100 is presented in one arrangement, other embodiments may include systems arranged otherwise depending, for example, on processing of currency conversions, type of messaging associated with authorization and clearing of transactions (e.g., single message, dual message, etc.), etc.

In the illustrated embodiment, the system 100 generally includes a merchant 102, an acquirer 104 associated with the merchant 102, a payment network 106, and an issuer 108 associated with a payment account provided to user 110, each of which is coupled to (and is in communication with) one or more networks. Each of the one or more networks is indicated by arrowed lines in FIG. 1, and each may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. As an example, one of the networks may include multiple different networks, such as a private payment transaction network made accessible by the payment network 106 to the acquirer 104 and the issuer 108 and, separately, the public Internet, which is accessible as desired to the merchant 102, the issuer 108 and a communication device 112 associated with the user 110, etc.

The merchant 102 in the system 100 is generally associated with products (e.g., goods and/or services, etc.) offered for sale to consumers and which may be purchased, as desired, by the consumers (including the user 110 acting as a consumer). The merchant 102 may offer the products for sale and sell the products through a physical storefront (i.e., a brick-and-mortar location), or through one or more mobile locations, websites, etc. In the illustrated embodiment, the merchant 102 is located in a foreign region, as compared to a native region of the user 110.

The acquirer 104 includes a banking institution or other financial institution, which has issued an account to the merchant 102, whereby funds associated with payment account transactions to the merchant 102 are delivered. In a similar manner, the issuer 108 includes a banking institution or other financial institution, which has issued a payment account to the user 110, and through which the user 110 is permitted to fund transactions with the merchant 102 and other merchants. The payment account may include, for example, a credit account, a debit account (e.g., a checking account or savings account, etc.), or a prepaid account, etc.

In addition, the acquirer 104 (as the banking institution or other financial institution) is associated with (and/or includes) an ATM 114, at which the user 110 may initiate account transactions to withdraw money from a payment account issued by the issuer 108. In connection therewith, the ATM 114 is configured to initiate a transaction by seeking authorization for the transaction from the issuer 108, in a similar fashion to a payment account transaction initiated at a point-of-sale (POS) terminal at the merchant 102, whereby the description herein of the configuration of and/or operations performed by the merchant 102 may apply, generally, to the ATM 114 as well. Further, the ATM 114 is coupled to (and/or is in communication) with the payment network 106, for example, through one or more networks, as illustrated by the arrowed lines in FIG. 1 (and as generally described above).

Further, in this exemplary embodiment, the payment network 106 is a dual message system, which includes an authorization network 106a and a separate clearing network 106b (i.e., a dual message scheme), as shown in FIG. 1. The authorization network 106a is configured to coordinate authorization of transactions, whereby the issuer 108, for example, provides approval for a transaction to proceed (when payment accounts issued by the issuer 108 are involved in the transactions), or declines a transaction. The clearing network 106b, on the other hand, is configured to coordinate clearing and settlement of approved transactions, whereby the relative financial positions (i.e., “due to the network” and “due from the network”) of different banking institutions, including the acquirer 104 and the issuer 108, are determined and funds are transferred consistent with the relative positions. While the two separate systems are provided within the system 100, each is still part of the payment network 106 and, therefore, may be referenced herein both as part of the payment network 106 and individually.

Notwithstanding the description of FIG. 1, the payment network 106 may include a single message system, which employs a single message scheme in other embodiments, whereby a single message is used for both authorization, clearing and settlement. In such embodiments, the payment network 106 may include the authorization network 106a but not the clearing network 106b (whereby the authorization network 106a may still be a separate part of the payment network 106, or whereby the payment network 106 may simply perform the operations of the authorization network 106a described herein).

With reference again to FIG. 1, the communication device 112 associated with the user 110 is configured to access and allow the user 110 to view one or more details of a payment account, as issued by the issuer 108 (e.g., balances, transactions, etc.) to the user 110, and to send and/or receive messaging to and/or from the issuer 108. In connection therewith, the communication device 112 includes a network-based application (not shown) associated with and/or provided by the issuer 108, which configures the communication device 112 to operate as described herein. The communication device 112 may include, for example, a smartphone, tablet, laptop, or other portable computing device (or other computing device), etc.

While only one merchant 102, one acquirer 104, one payment network 106, one issuer 108, one user 110, one communication device 112, and one ATM 114 are illustrated as included in the system 100 of FIG. 1, it should be appreciated that any number of these entities and/or persons (and their associated components) may be included in the system 100, or may be included as a part of systems in other embodiments, consistent with the present disclosure.

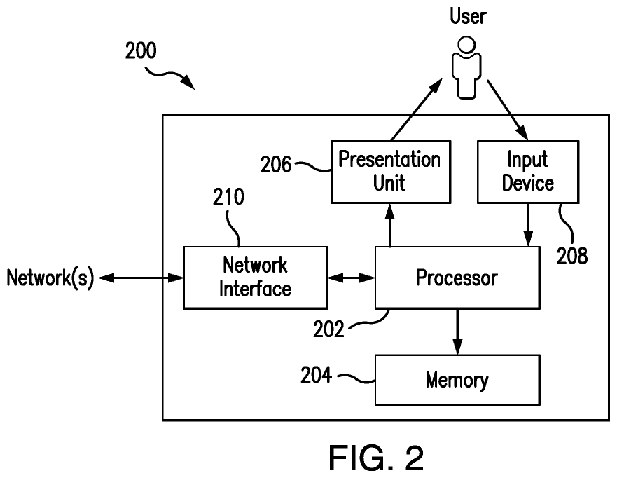

FIG. 2 illustrates exemplary computing device 200 that can be used in the system 100. The computing device 200 may include, for example, one or more servers, workstations, personal computers, laptops, tablets, smartphones, POS devices, etc. In addition, the computing device 200 may include a single computing device, or it may include multiple computing devices located in close proximity or distributed over a geographic region, so long as the computing devices are specifically configured to function as described herein. In particular, in the exemplary system 100 of FIG. 1, each of the acquirer 104, the payment network 106, and the issuer 108, may include, or may be implemented in, a computing device such as the computing device 200. In addition, the merchant 102 (or more specifically, a POS terminal at the merchant 102) and the ATM 114 may each be considered a computing device consistent with the computing device 200. Further, the communication device 112 associated with the user 110 may be considered a computing device consistent with the computing device 200. That said, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data (e.g., amounts of transactions, authorization identifiers (e.g., as designated authorization IDs, etc.) for transactions, rate file identifiers (e.g., as designated RateFileIDs, etc.), transaction currencies, cardholder billing currencies, currency codes, primary account numbers (PANs), issuer identifiers, etc.), rate files, conversion rates, and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information (e.g., conversion rate options, etc.), either visually or audibly, to a user of the computing device 200, for example, the user 110, users associated with other parts of the system 100, etc. Various interfaces may also be displayed at computing device 200, and in particular at presentation unit 206, to display such information. The presentation unit 206 may include, without limitation, a presentation unit such as a liquid crystal display (LCD), a light-emitting diode (LED) display, an organic LED (OLED) display, an “electronic ink” display; speakers; another computer; etc. In some embodiments, the presentation unit 206 may include multiple devices.

The computing device 200 also includes an input device 208 that receives inputs from the user of the computing device 200 (i.e., user inputs). The input device 208 is coupled to (and is in communication with) the processor 202 and may include, for example, a keyboard, a pointing device, a mouse, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), a mobile network adapter, or other device capable of communicating to/with one or more different networks (e.g., as indicated by the arrowed lines in FIG. 1, etc.). Further, in some exemplary embodiments, the computing device 200 may include the processor 202 and one or more network interfaces (including the network interface 210) incorporated into or with the processor 202.

Referring again to FIG. 1, the system 100 includes a conversion engine 116, and a rate file data structure 118 coupled thereto (and in communication therewith). The conversion engine 116 is specifically configured, by executable instructions, to perform one or more of the operations described herein. In connection therewith, the conversion engine 116 and the data structure 118 may each (separately or together) be considered a computing device consistent with computing device 200. And, while the conversion engine 116 and the data structure 118 are illustrated as separate parts of the system 100 in FIG. 1, one or both may be incorporated into and/or located at one or more other parts of the system 100, such as, for example, the payment network 106, etc. In addition, while the rate file data structure 118 is illustrated as separate from the conversion engine 116 in FIG. 1, in other embodiments the data structure 118 may be included, or integrated, in the conversion engine 116, for example, in memory 204 therein, as indicated by the dotted line, etc.

In various exemplary embodiments, the rate file data structure 118 may include one or more rate files, each of which provides a series of currency conversion rates between two currencies. Exemplary rate files are described below. Further, in one or more such embodiments, the rate file data structure 118 may also include the one or more rate files stored in association with authorization IDs for transactions, whereby during clearing, for example, the rate files can then be identified back to the desired transactions based on the authorization IDs.

With that said, when the user 110 initiates a transaction at the merchant 102 or the ATM 114, an authorization request (including an authorization ID for the transaction) is compiled and provided to the acquirer 104 (via a network connection there between). In turn, the acquirer 104 is configured to transmit the authorization request to the payment network 106.

In response, the authorization network 106a of the payment network 106 (or the conversion engine 116 via communication with the authorization network 106a of the payment network 106, etc.) is configured to identify the authorization request as requiring a currency conversion (e.g., based on a difference in a card holder billing currency (or a code therefore) included in the authorization request and a transaction currency (or a code therefore), or based on the difference between an issuer settlement currency (or a code therefore) included in the authorization request and a transaction currency (or a code therefore)), etc. The conversion engine 116 is configured to then determine the currency conversion rate for the transaction (i.e., a current currency conversion rate). The conversion engine 116 is configured to calculate the transaction amount based on the amount included in the authorization request in the user's billing currency and to append the transaction amount to the authorization request. The conversion engine 116 and/or the payment network 106 (i.e., the authorization network 106a thereof) is then configured to pass the authorization request (as modified to include the calculated transaction amount) on to the issuer 108.

In addition, in this example embodiment, the conversion engine 116 is configured to store the determined currency conversion rate for the given transaction in the rate file data structure 118 (together with similar entries for other transactions), with the rate referenced by (or associated with) a rate file identifier (e.g., a date and time of the transaction, a date and time of authorization of the transaction, a merchant category code (MCC) for the merchant 102 (or the ATM 114), the authorization ID from the authorization request, etc.). For example, the currency conversion rate may be stored in the rate file data structure 118 and linked to an authorization ID from the authorization request, a time and date of the transaction and/or the authorization request, an MCC for the merchant 102 (or the ATM 114), a type of the transaction, etc.

In connection therewith, Table 1 illustrates an exemplary segment of the rate file data structure 118 in which the transaction may be stored along with similar data for other transactions. As shown, the exemplary segment of the rate file data structure 118 includes, for each of the multiple transactions, a currency conversion rate (CCR), a transaction type, a merchant MCC, a time and date of the transaction, and a time interval. As indicated from Table 1, the CCR may be specific to the given transaction type, MCC, or other data related to the transaction, the issuer of the payment account used in the transaction, the merchant involved in the transaction, or the user performing the transaction, etc.

TABLE 1

| Currency | Transac- | | | Time |
|---|---|---|---|---|
| Conversion Rate | tion Type | MCC | Time and Date | Interval |
| 1.10 USD per EUR | Retail | Airline | 07:15:26, Oct. 1 | 5 days |
| 1.10 USD per EUR | Retail | Restaurant | 08:15:44, Oct. 1 | 5 days |
| 1.11 USD per EUR | Cash | Money | 22:45:52, Oct. 1 | 2 days |
| | Transfer | Transfer | | |
| 6.65 USD per ¥ | Retail | Pharmacy | 22:45:52, Oct. 1 | 5 days |
| (YUAN) | | | | |
| 1.08 USD per EUR | ATM | Hotel | 15:06:02, Oct. 2 | 7 days |

With that said, the rate file data structure 118 (e.g., the exemplary segment illustrated in Table 1, etc.) may be configured to maintain the currency conversion rate (CCR) therein for at least a time interval (e.g., the time interval indicated in Table 1, etc.), which may include, for example, one day, multiple days, one week, one month, multiple months, or more or less time, etc., during which the currency conversion rate stored therein for the given transaction is valid (e.g., for subsequent clearing of the transaction, etc.). After the time interval, the rate file data structure 118 may then be configured to delete, purge, or otherwise remove the currency conversion rate therefrom (whereby clearing of the transaction would then be based on a current currency conversion rate).

With continued reference to FIG. 1, upon receipt of the authorization request, the issuer 108 evaluates the transaction and, in turn, is configured to compile and transmit an authorization reply, in response to the authorization request, wherein the issuer 108 either approves or declines the transaction. In addition, the issuer 108 may be configured to transmit a notice message to the user 110 at the communication device 112, which includes the converted amount for the transaction, and/or is configured to post the transaction (with the converted amount) to the transaction record for the user's payment account (as pending) (which is then viewable by the user 110 and whereby the user 110 is able to review the calculated/converter transaction amount). In at least one embodiment, the notice message is transmitted to the merchant 102 and/or the ATM 114 (rather than the communication device 112) consistent with an authorization message format (e.g., consistent with the ISO 8583 standard, etc.) to be displayed to the user 110. Regardless of how the notice message is transmitted, it may include, without limitation, a merchant name for the merchant 102 (or the ATM 114), a transaction amount, a currency conversion rate, a date and time of transaction, a location of the merchant 102 (or the ATM 114), other suitable identifying information about the merchant 102 (e.g., phone number, address, etc.), an authorization ID, and/or a transaction ID assigned to the transaction, etc.

In response to receiving the authorization reply from the issuer 108, the payment network 106 (e.g., the authorization network 106a of the payment network 106, etc.) is configured to transmit the authorization reply to the acquirer 104, which in turn, is configured to provide (or forward) the authorization reply to the merchant 102 or the ATM 114 (whichever initiated the transaction). When the transaction is approved by the issuer 108 (in the authorization reply), the acquirer 104 and the issuer 108 are configured to store the transaction to a transaction log (e.g., in corresponding memory 204 thereof, etc.). Further, at some time after the transaction is authorized (e.g., that same day, the next day, or on a later date, etc.), the acquirer 104 is configured to submit the transaction to the payment network 106 for clearing and settlement (e.g., to the clearing network 106b of the payment network 106, etc.), for example, in the form of a batch file with several other transactions.

As part of the clearing process, then (e.g., upon receipt of a batch file from the acquirer 104, etc.), the payment network 106 (and specifically, the conversion engine 116) is configured to request, from the rate file data structure 118, the determined currency conversion rate for the transaction based on the rate file identifier for the transaction (e.g., the time and date of the transaction or of authorization of the transaction, the MCC of the merchant 102 involved in the transaction, the type of transaction, the authorization type, the authorization ID, etc.). And, the rate file data structure 118 is configured to return the identified currency conversion rate to the payment network 106 based on the rate file identifier (directly, or via the conversion engine 116, etc.). In certain embodiments, the currency conversion rate maintained in the rate file data structure 118 is then usable in clearing the transaction whenever the transaction is ultimately submitted for clearing (e.g., as long as it is consistent with terms and conditions associated with the transaction and/or the payment network 106 and/or the user's payment account, etc.). In so doing, the identified currency conversion rate (from the rate file data structure 118) may be considered a fixed rate, and is not based on a current (or present) currency conversion rate.

In various embodiments, the rate file data structure 118 may include a time interval during which the currency conversion rate stored therein is valid, as explained above (and as shown in Table 1). This may be defined by a maximum clearing date for the transaction, whereby for transactions submitted for clearing on or before the maximum date, the rate file data structure 118 returns the conversion rate stored therein. Conversely, when such transactions are submitted for clearing beyond the maximum date (i.e., outside the time interval), the rate file data structure 118 may return an error or no currency conversion rate, whereby the current currency conversion rate is to be used (even if it is different from the currency conversion rate originally identified by the conversion engine 116). The time interval provided may depend on the type or category of merchant and/or ATM at which the given transaction is initiated. For example, an ATM transaction may be provided more or less time for clearing at the fixed currency conversion rate (i.e., the rate determined by the conversion engine 116, etc.) than a transaction at a restaurant merchant. Again, the time interval may be flexible and dependent on business needs of a particular merchant and/or category of merchants. For instance, in the above example, the conversion engine 116 may provide slightly longer time intervals to the restaurant merchant (or other similar merchants) as it may involve transactions involving a subsequent tip, in order to allow for the time interval between the original authorization of the transaction and the subsequent addition of the tip to the transaction. Furthermore, in other examples, longer time intervals may be provided for transactions for hotel stays or rental cars to allow for the time between original transaction authorization and when the service is complete (e.g., checking out in 10 days after an original authorization from a hotel, etc.). In still further examples, the conversion engine 116 may provide longer intervals for e-commerce transactions where shipping rates will be determined at shipment (instead of at the time of purchase) or where an item ships in multiple parts and it takes time to complete the whole shipment.

It should be further appreciated that the conversion engine 116 may be configured to apply and/or add a fee for the fixed currency conversion rate service provided herein, for example, depending on an MCC of the merchant 102 (or other involved merchants). In particular, for example, the conversion engine 116 may be configured to add a fee to fix the currency conversion rate for transactions with longer intervals like hotels or rental cars due to the increased risk of holding the exchange rate constant, and to not add a fee for other transactions. The inclusion of the fee may be an option to the issuer 108 (or other issuers) (e.g., an opt-in fee, etc.) based on the time intervals to be applied, where the fee is either fixed and/or variable based on the time interval. It should further be appreciated that the conversion engine 116 may be configured to omit transactions from being provided with a fixed currency conversion rate based on a type of category of merchants involved in the transactions and/or a type of the transactions themselves (e.g., an e-commerce transaction where the item is expected to be shipped after an extended time after the original authorization (e.g., 30 days, etc.), etc.). In these examples, the conversion engine 116 may be configured to either not store a currency conversion rate, or to assign a time interval of zero (whereby the time interval is expired regardless of when the transaction is submitted for clearing and settlement).

In any case, in response to the received currency conversion rate, the payment network 106 is configured to convert the amount of the transaction, as included in the batch file for the acquirer 104, based on the currency conversion rate from the rate file data structure 118 (and add a fee for the service, if applicable) and to clear the transaction between the acquirer 104 and the issuer 108 based on that converted amount (and fee, if applicable). The payment network 106 is further configured to notify the issuer 108 of the final cleared amount for the transaction (i.e., the converted amount). And, the issuer 108 is configured to post the transaction to the billing statement for the payment account at the final cleared amount (viewable by the user 110), which generally will be the same amount as originally posted and/or presented to the user 110.

It should be appreciated that the above description (with reference to Table 1) is one example of how the rate file data structure 118 may be compiled within the system 100. Alternatively, in one variation of the system 100, the conversion engine 116 may be configured to utilize a specific rate file identifier, which is indicative of a particular rate file, where each rate file includes currency conversion rates between different currencies. In other words, the rate files may include a listing of all currency pairs that can be processed by the system 100 and a currency conversion rate associated with each one (for the given date, etc.), for example, EUR-USD 1.12, GBP-USD 1.32, AUD-CAD 1.27, etc. The rate files may be compiled daily, or at another suitable interval, to include current currency conversion rates for when the rate file is compiled. The rate file identifier of a particular rate file is then linked to particular example transactions, based on transaction type, MCC, date and time, etc., in a data file (generally indicating transactions that are eligible for currency conversion as described herein) where each of the rate files and the data files are stored in the rate file data structure 118 for use in converting transaction amounts. In short, the rate file data structure 118 may include a rate file or multiple rate files at any point in time, each associated with a unique rate file identifier that can be assigned to a transactions during authorization.

As an example, Table 2 illustrates an exemplary segment of a rate file within the rate file data structure 118. As shown, the exemplary segment includes a transaction currency and a user (or cardholder) currency (defining a currency pair), and a corresponding currency conversion rate associated therewith. This rate file is associated with a rate file identifier (e.g., 12345, etc.), which may be used as the basis to identify the required currency conversion rate in Table 2.

TABLE 2

| Transaction Currency | User Currency | Currency Conversion Rate |
|---|---|---|
| EUR | USD | 1.12 |
| GBP | USD | 1.32 |
| AUD | CAD | 1.27 |

As indicated, the rate file data structure 118 also includes the data files (generally indicating transactions that are eligible for currency conversion as described herein), which link transactions to the particular rate files, by the rate file identifier and parameters of the transactions (based on MCC, type of transaction, type of authorization, etc.). The data files may also indicate a time interval between authorization and clearing (in similar fashion to the time interval included in Table 1) where the rate as of the time of authorization will apply. If the transaction is submitted for clearing after the indicated time frame, the clearing network 106b of the payment network 106 will not utilize the rate file identifier associated with the time of authorization, but rather the prevailing currency conversion rate as stored in the latest rate file available at the time (again, in a similar manner to the embodiment described above with reference to Table 1). That said, Table 3 illustrates an exemplary segment of a data file within the rate file data structure 118. As show, the exemplary segment includes a listing of transaction types, MCCs, authorization types, time intervals, and rate files. In other embodiments, data files may include more or less information for each transaction entry. For example, in some embodiments, data files may also include a date/time associated with the given rate file (from which the time interval runs or extends), and authorization ID linked to the given rate file, etc.

TABLE 3

| Transaction | | Authorization | Time | Daily Rate |
|---|---|---|---|---|
| Type | MCC | Type | Interval | File to Use |
| ATM | Hotel | Final authorization | 8 days | Rate File 1 |
| Retail | Airline | Pre-authorization | 3 days | Rate File 1 |
| Cash transfer | Vacation | Final authorization | 2 days | Rate File 2 |
| | Rentals | | | |

In connection with the embodiment associated with Tables 2 and 3, when the currency conversion engine 116 receives a transaction involving currency conversion, it is configured to reference the data file of the data structure 118 (e.g., the segment illustrated in Table 3, etc.), to determine eligibility of the given transaction for currency conversion (as described herein) and, depending on the characteristics thereof (e.g., is the given transaction eligible based on the type, MCC, time interval, etc.), the currency conversion engine 116 is then configured to reference the appropriate rate file associated with the transaction to perform the conversion (as part of the authorization). And, in turn, the currency conversion engine 116 is configured to transmit the converted amount and the unique rate file identifier of the rate file that was used to perform the conversion back to the authorization network 106a of the payment network 106 (whereby the authorization network 106a is configured to transmit the corresponding authorization request for the transaction to the issuer 108, as described above).

Then, subsequently, when the acquirer 104 submits transactions for clearing (which would include information on the rate file identifier used in the authorization of the transactions), the clearing network 106b is configured to use the currency conversion engine 116 to perform the conversion. The currency conversion engine 116, again, is configured to reference the data file (e.g., the segment illustrated in Table 3, etc.) to determine whether the received transaction(s) is/are eligible for using the currency conversion rate at of the time of clearing (by again identifying the transaction type, MCC, time interval value, etc.). If the transaction is not eligible (for example, the transaction was submitted for clearing past the eligibility period as indicated by the time interval value for such transaction), the conversion engine 116 is configured to use the then current rate file to perform the conversion. However, if the transaction is eligible for using the same currency conversion rate as of authorization, the conversion engine 116 is configured to reference the rate file identifier associated with the transaction and use the corresponding currency conversion rate from the rate file associated with that rate file identifier.

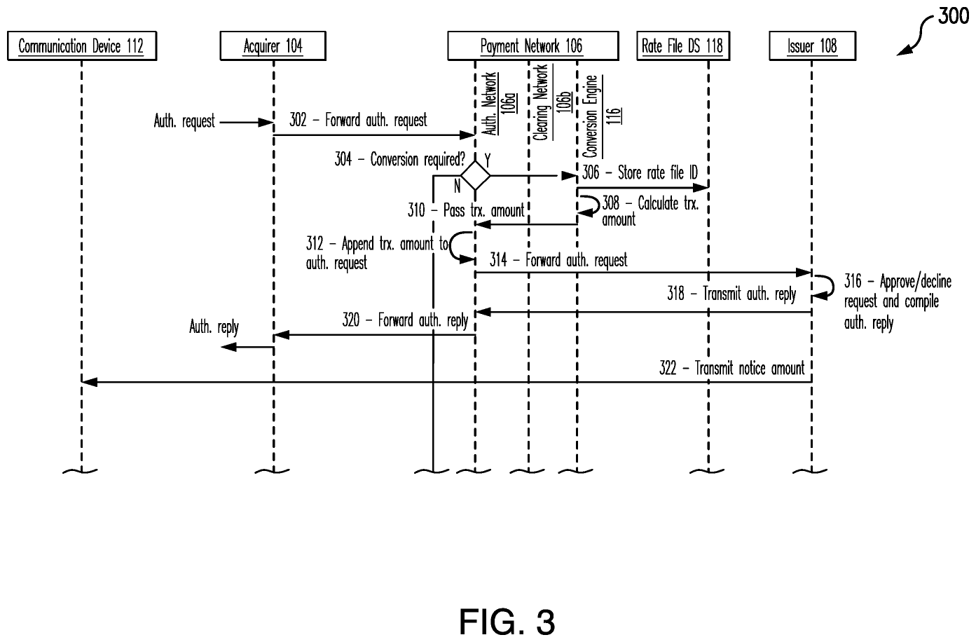

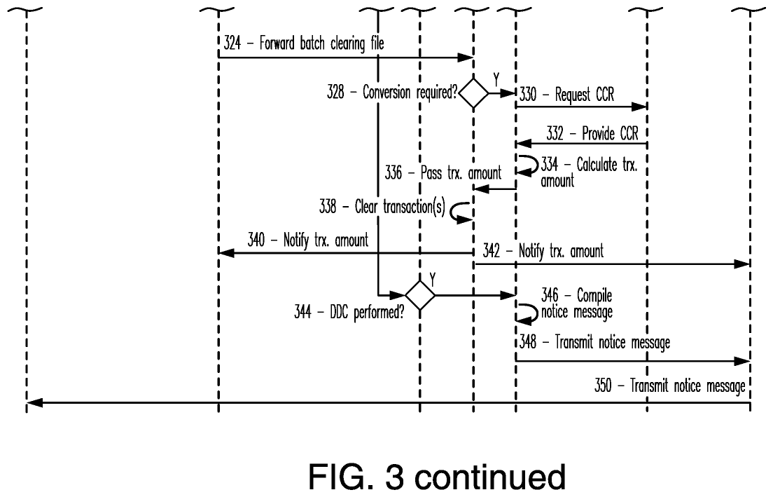

Further, in another variation of the system 100, during authorization of transactions, the conversion engine 116 may be configured to link (or store), in the rate file data structure 118 (e.g., in the data file of FIG. 3, etc.), the authorization IDs for the transactions (as generated in connection with the authorization requests for the transactions) to particular rate files (e.g., to particular rate file identifiers for the rate files, etc.) corresponding, for example, to the date(s) of the transactions. Table 2, again, illustrates an exemplary segment of a rate file within the rate file data structure 118 that may be used for such linking in the data file (e.g., in the data file of FIG. 3, etc.). As described above, the exemplary rate file includes a listing of all currency pairs that can be processed by the system 100 and a currency conversion rate associated with each one (for a given date, etc.), for example, EUR-USD 1.12, GBP-USD 1.32, AUD-CAD 1.27, etc. Then, during clearing, for a given transaction, the conversion engine 116 may be configured to identify the particular rate file (or rate file identifier) to be used with the transaction based on the authorization ID for the transaction (whereby the rate file then may also correspond to the date of the transaction, etc.).

In connection with this embodiment, when the currency conversion engine 116 receives a transaction involving currency conversion, it is configured to store an authorization ID for the transaction in the data structure 118 (e.g., in the data file of FIG. 3, etc.) in association with a rate file (or a rate file identifier therefore) (e.g., the segment illustrated in Table 2, etc.), for example, based on a date of the transaction (e.g., such that the transaction is linked to the rate file having the currency conversion rates therein for the same time/day of the transaction, etc.). In turn, the currency conversion engine 116 is configured to convert the amount of the transaction (based on the appropriate currency conversion rate from the rate file) and transmit the converted amount back to the authorization network 106a of the payment network 106 (whereby the authorization network 106a is configured to append the converted amount to the authorization request for the transaction and transmit the authorization request to the issuer 108, as described above).

Then, subsequently, when the acquirer 104 submits the transaction for clearing (which would include the authorization ID of the authorization request for the transaction), the clearing network 106b is configured to use the currency conversion engine 116 to perform the conversion. The currency conversion engine 116 is configured to reference the data file (e.g., the segment illustrated in Table 3, etc.) to determine whether the received transaction is eligible for using the currency conversion rate at of the time of clearing (e.g., by identifying the transaction type, MCC, time interval value, etc.). If the transaction is not eligible (for example, the transaction was submitted for clearing past the eligibility period as indicated by the time interval value for such transaction type), the conversion engine 116 is configured to use the then current rate file to perform the conversion. However, if the transaction is eligible for using the same currency conversion rate as of authorization, the conversion engine 116 is configured to reference the authorization ID for the transaction to the corresponding rate file (or rate file identifier) in the data file and use the corresponding currency conversion rate from the rate file associated therewith to convert the transaction amount.

In another aspect of the present disclosure, upon presenting a payment device to the merchant 102 and/or the ATM 114, the terminal associated therewith may invite the user 110 to initiate the payment account transactions in the native currency for the payment account (i.e., in the user's home currency). For example, for a transaction in Germany by user 110 where the user's payment account has a native currency of U.S. dollars, the given terminal may offer the user 110 an option to initiate the transaction in U.S. dollars (instead of Euros). This option for dynamic currency conversion (DCC) is provided by the merchant or the ATM, and/or the banking institution associated therewith (as a DCC provider), and often includes fees, mark-ups, and/or other charges. When the user 110 accepts the DCC invitation/option, the payment account transaction is initiated in the user's native currency (i.e., US dollars in this example) as a DCC transaction, in an amount equal to the amount of the transaction based on the currency conversion rate (DCC rate) set by the merchant or ATM and/or the associated banking institution (e.g., the acquirer 104, etc.), plus the additional fees, mark-ups, and/or other charges as provided. In this exemplary embodiment, when DCC is applied at the point of the transaction (e.g., at the merchant 102 or the ATM 114, etc.), the authorization request includes a local currency indicator (e.g., an indicator that the local currency is Euros, etc.), the original amount of the transaction in the foreign currency, and the transaction amount as provided in the native currency of the user's account (at the DCC rate), etc.

Then in this aspect, upon receipt of the authorization request, the payment network 106, and in particular, the authorization network 106a, is configured to identify the transaction as being associated with DCC, based on the inclusion of the two amounts in different currencies (or through other suitable information included in the authorization request or otherwise) and/or, potentially, based on a DCC flag included in the authorization request (e.g., where the flag is included by the merchant 102 and/or the acquirer 104, etc.). In turn, the authorization network 106a of the payment network 106 (or the conversion engine 116) is configured to generate and transmit a notice message to the issuer 108, which includes the final transaction amount, the original amount for the transaction in the user's native currency, an implied conversion rate for the transaction (i.e., the transaction amount divided by the original amount), the network conversion rate for the conversion (i.e., the currency conversion rate as calculated by the conversion engine 116, as opposed to the DCC conversion rate), the final transaction amount at the network conversion rate, and a difference between the transaction amount at the network conversion rate and the transaction amount at the DCC conversion rate. The notice message also includes an interval for which the network currency conversion rate will remain the same. For example, where the network currency conversion rate changes daily, the notice message may include an indication that the network currency conversion is valid for transactions submitted until 2:59 PM (local time, or native time, as applicable), or for transactions submitted throughout the next time interval (e.g., the next 5 hours and 23 minutes, etc.), etc. In addition, the notice message may include a common format (e.g., an XML format, etc.) so that the message is easily accepted by one or more issuers, etc. Alternatively, the authorization network 106a may notify the conversion engine 116 that DCC applies, and the conversion engine 116 is configured to then generate and transmit the notice message to the issuer 108.

Finally in this aspect, in response to the notice message, the issuer 108 is configured to pass and/or transmit the notice message to the user 110, at the communication device 112, in whole or in part, thereby notifying the user 110 of the rate comparison of selecting to proceed with the transaction in the user's native currency by means of DCC.

In still another aspect of the present disclosure, yet consistent with the above, a transaction by the user 110 may be associated with multiple authorization requests and a single clearing request. For example, a transaction for a hotel stay (e.g., where the merchant 102 is a hotel, etc.) by the user 110 may include an authorization request upon checking-in for a certain amount and then incremental authorization requests for incremental amounts if the user 110 decides to elongate their stay beyond the original booking or, potentially, if the user 110 decides to charge additional services or products to their room during the stay. In various embodiments, then, the authorization network 106a of the payment network 106 is configured to track the initial authorization request, and each subsequent incremental authorization request thereafter related to the initial authorization (e.g., by the associated authorization ID, etc.). That is, the acquirer 104 is configured to append the authorization ID for the initial authorization request to each subsequent incremental authorization request to record the subsequent incremental authorization requests to a data structure (e.g., in memory of the acquirer 104, etc.), thereby maintaining a record of the authorization requests that form part of the single transaction.

Thereafter, in connection with clearing the single transaction, the acquirer 104 is configured to submit a batch file, which includes an authorization ID for the initial authorization request and also for each subsequent incremental authorization request. When the batch file is received, the clearing network 106b of the payment network 106 is configured to pass the transaction to the conversion engine 116 (including the transaction amount associated therewith). In addition to the transaction amount, the clearing network 106b of the payment network 106 is configured to also pass the time and/or date of the last authorization request or the final authorization request (or a different one of the authorization requests), etc. The conversion engine 116, in turn, is configured to request, from the rate file data structure 118, based on the rate file identifier for the given transaction (e.g., by the time and/or date of the last authorization request, etc.) and to calculate the transaction amount (taking into account the corresponding currency conversion rate). It should be appreciated that in addition to the time and/or date of the last authorization request, the category of the merchant, the transaction type, or other information from the authorization request(s) may be used, by the conversion engine 116, to request the proper rate from the rate file data structure 118. In particular, even when the transaction is authorized at the same time, the rate may be different based on the transaction type and/or the MCC of the merchant 102. In addition to the rate itself, as also described above, the time interval for which the rate will be used, may also vary depending on the type of the transaction and/or the MCC, etc.

Then in this aspect, once calculated, the conversion engine 116 is configured to provide the final amount back to the clearing network 106b of the payment network 106, which is configured, as described above, in turn, to clear and settle the transaction. Further, notice messages may be transmitted to the issuer 108 and/or the user 110 consistent with the description above.

In a yet another aspect of the present disclosure, the system 100 may be configured to provide a combination of both single message schemes (i.e., when authorization and clearing happen at the same time) and dual message schemes (i.e., when authorization happens first and clearing happens in batch later). In particular, the system 100 may include a shared conversion engine 116 between both schemes, or each scheme may include its own conversion engine 116. Regardless, in these aspects of the disclosure, the conversion engine 116 is configured to interact with the same rate file data structure 118 for either the single message or dual message schemes.

In connection therewith, when a transaction is originated in the single message scheme (i.e., with the acquirer 104 submitting the transaction to the payment network 106), but finishes in a dual message scheme (i.e., where the issuer 108 interacts with the payment network 106 through a dual message scheme) (as in system 100), the clearing network 106b of the payment network 106 is configured to employ the authorization ID from the single message scheme, as included by the acquirer 104 as the rate file identifier or a link to the rate file identifier, and then to use the rate file identifier (e.g., authorization ID, time and date of the authorization request, MCC of the merchant 102, the transaction type, etc.) to calculate cardholder billing amounts (in connection with clearing and settlement). In this manner, the rate file identifier is linked to the same currency conversion rate, because either the conversion engine 116 is the same for the two schemes, or the conversion engine 116 is different for the two different schemes yet is using the same rate file data structure 118 to request the appropriate currency conversion rate. Conversely, when the transaction is originated in the dual message scheme (i.e., the acquirer 104 is submitting it to the payment network 106) (as in system 100), but finishes in a single message scheme (i.e., the issuer 108 is configured to interact with the payment network 106 through a single message scheme), the payment network 106 may be configured to use the authorization ID from the dual message scheme as the rate file identifier or a link to the rate file identifier and then to pass the rate file identifier to the conversion engine 116 to store/request/retrieve the currency conversion rate to/from the rate file data structure 118. As above, the rate file identifier is consistent between the two message schemes, and therefore, will result in a consistent currency conversion rate from the rate file data structure 118. Therefore, this aspect of the disclosure will ensure that the currency conversion rate is the same between authorization and clearing regardless of which scheme is used to originate the transaction and which scheme is used to “receive” the transaction.

FIG. 3 illustrates an exemplary method 300 for use in providing a fixed currency conversion rate for a transaction, during authorization, whereby the transaction is then cleared at the fixed currency conversion rate. The exemplary method 300 is described with reference to the system 100, and the payment network 106 and the conversion engine 116 thereof, etc. Further reference is also made to the computing device 200. However, it should be understood that the methods herein are not limited to the system 100 or the computing device 200, as the method 300, for example, may be implemented, at least in part, in other parts of the system 100 or in other suitable systems, or in multiple other computing devices. Likewise, the systems and the computing devices herein should not be understood to be limited to the exemplary method 300.

In the exemplary method 300, the user 110 initiates a payment account transaction at the merchant 102 for a product with a cost of €100.00 (where the local currency for the merchant 102 is Euros (€), and where the merchant 102 is located in a foreign region (e.g., Country B, etc.) as compared to the native or home region of the payment account (e.g., Country A, etc.) (and where the consumer's native or home currency is U.S. dollars ($)). In connection therewith, the user 110 presents credentials for his/her payment account to the merchant 102 and/or the ATM 114, for example, by swiping, contacting, waving, etc., a payment card (or virtual wallet included in the communication device 112), etc. In response, the merchant 102 compiles an authorization request and transmits the authorization request to the acquirer 104. The authorization request includes, for example, a PAN for the user's payment account, a native currency indication (or code) for the user's payment account (i.e., U.S. dollars), a transaction amount for the transaction in Euros (i.e., €100.00), a currency code for the merchant 102 indicative of Euros, and other suitable data.

In turn, the acquirer 104 receives the authorization request and, at 302, forwards the authorization request to the payment network 106, and in particular to the authorization network 106a of the payment network 106. In response, the payment network 106 identifies the transaction as involving a currency other than the user's native currency, whereby it determines whether conversion is required, at 304. This may be accomplished by comparing the currency code in the authorization request to the currency code of the native currency of the payment account. Then, when the transaction requires currency conversion, the payment network 106 (and specifically, the authorization network 106a) passes the authorization request to the conversion engine 116, in whole or in part. For example, the authorization network 106a may pass only limited information from the authorization request, including the transaction currency, cardholder billing currency, and settlement currency (and a transaction identifier), etc. Upon receipt, the conversion engine 116 identifies a currency conversion rate for the transaction (e.g., a current conversion rate for Euros to U.S. dollars, etc.) (e.g., 1.10 USD per EUR, etc.) and stores, at 306, the identified currency conversion rate in the rate file data structure 118 based on a rate file ID for the underlying transaction (e.g., the date and/or time of the transaction, the date and/or time of authorization of the transaction, an authorization ID included in the authorization request, or other suitable information, etc.). In short, the currency conversion rate is stored in a manner than permits subsequent retrieval of the rate from the data structure 118 for the given transaction, as described below. It should be appreciated that the currency conversion rate may be specific to a MCC and/or transaction type, whereby the currency conversion rate may be different for transactions having different MCCs despite a consistent time and date of the transactions and transaction type. The MCC and/or the transaction type for a given currency conversion rate, when applicable, may be apparent from the rate file ID, or apparent within the rate file data structure 118.

While the conversion engine 116 stores the currency conversion rate in the method 300, it should be appreciated that when rate files and data files are included in the rate file data structure 118 the currency conversion engine 116 may instead retrieve the appropriate currency conversion rate based on matching the transaction (based on MCC, transaction type, authorization type, etc.) to a rate file identifier and retrieve the currency conversion rate for the currencies involved in the transaction from the rate file indicated by the rate file indicator.

Regardless, at 308, the conversion engine 116 calculates a converted transaction amount for the transaction, as, in this example, €100.00×1.10 USD per EUR currency conversion rate, to provide a final transaction amount, $110.00 in this example. The transaction amount is then passed back to the authorization network 106a of the payment network 106, at 310, whereupon the authorization network 106a appends, at 312, the converted transaction amount to the authorization request. And, the authorization network 106a of the payment network 106 forwards the authorization request (including the converted transaction amount, i.e., $110.00 in this example) to the issuer 108, at 314.

Upon receipt of the authorization request, the issuer 108 determines to approve or decline the transaction and compiles, at 316, an authorization reply therefor. The transaction may be approved or declined, based on a standing of the user's payment account, a balance of the payment account, or other suitable criteria for evaluating the transaction (e.g., fraud scoring, etc.), etc. The authorization reply is then transmitted, by the issuer 108, at 318, to the payment network 106 (specifically, the authorization network 106a of the payment network 106). In response, the payment network 106 forwards, at 320, the authorization reply to the acquirer 104. And as is conventional, the authorization reply is passed back to the merchant 102, at which the transaction originated. In connection therewith, when the transaction is approved by the issuer 108, the acquirer 104 and the issuer 108 also append the transaction to respective batch clearing files (for use in subsequently clearing and settling the transaction).

In connection with approving (or declining) the transaction, the issuer 108 also transmits, at 322, a notice of the converted transaction amount to the user 110, at the communication device 112. The notice may be transmitted as a SMS message, an email, or a notice to a network-based application installed at the user's communication device 112, etc. The notice includes, as indicated, an amount of the transaction as provided by the applied currency conversion rate, and may include additional information such as, for example, the name of the merchant 102 at which the transaction occurred, etc., whereby the user 110 is permitted to correlate the amount to the particular transaction, and appreciate the actual amount of the transaction in the user's native currency (i.e., $110.00). The notice may be transmitted immediately after the transaction is approved (or declined), or at some time after the authorization reply is compiled and transmitted.

Next in the method 300, clearing of the transaction (when approved by the issuer 108) may be performed at various intervals, including, for example, once per day, multiple times per day, or less than once per day (based on the batch clearing files generated by the acquirer 104 and/or the issuer 108). In particular in the method 300, and consistent with the clearing interval of the payment network 106, for example, the acquirer 104 forwards, at 324, a batch clearing file (including the given transaction) to the payment network 106, and in particular, the clearing network 106b of the payment network 106. It should be appreciated that the acquirer 104 may forward the batch clearing file (including the given transaction) on the same day the transaction was authorized or another day subsequent to initial transaction authorization (e.g., multiple days after the transaction authorization, etc.).

In turn, the payment network 106 again (this time the clearing network 106b of the payment network 106) determines whether the transaction requires currency conversion, at 328. When required (e.g., based on a difference in the currency code for the merchant 102 involved in the transaction and a native currency for the user's payment account (as included in the batch clearing files), etc.), the clearing network 106b passes a request related to the transaction (e.g., including suitable information to make the conversion, etc.) to the conversion engine 116.

In response, the conversion engine 116 requests, at 330, the currency conversion rate (CCR in FIG. 3) for the transaction, based on the rate file ID for the transaction (e.g., the date and/or time of the transaction, the MCC for the merchant 102, the authorization ID for the transaction (e.g., an authorization ID for an initial authorization request or subsequent authorization request for multi-authorization transactions, etc.), an authorization ID for a single message scheme, etc.). The rate file data structure 118 identifies the currency conversion rate, based on the rate file ID (either directly (depending on the type of rate file ID) or based on the data file (e.g., MCC, authorization type, transaction type, etc.)), and provides, at 332, the currency conversion rate back to the conversion engine 116. Furthermore, when the currency conversion rate is subject to a time interval within the rate file data structure 118, the rate file data structure 118 will also determine if the clearing date (i.e., the date upon which the currency conversion rate is requested for the transaction) is beyond the time interval for which the currency conversion rate is to be fixed. This allotted time interval may be constant, or may be different based on various criteria, including, without limitation, issuer preferences, categories of the merchants (e.g., MCC, etc.) and/or a type of transaction, etc. When the clearing date is within the allotted time interval, as in the above example, the rate file data structure 118 provides the stored currency conversion rate, as stored for the given rate file ID (and MCC, transaction type, authorization type, etc., as applicable), to the conversion engine 116. However, when the clearing date is outside the time interval, the rate file data structure 118 provides a current currency conversion rate, or an instruction to use a current currency conversion rate known, to the conversion engine 116. For certain transactions, depending on various criteria, such as, for example, MCC, transaction type (e.g., ATM versus POS, etc.), etc., the allotted time interval may be zero, whereby the transaction will be subject to the current currency conversion rate and not eligible to use the stored currency conversion rate.

Upon receipt of the currency conversion rate (or the instruction to use a current currency conversion rate), the conversion engine 116 calculates, at 334, the clearing transaction amount for the transaction (i.e., for the single authorization or multi-authorization transaction) based on the transaction amount included in the batch file(s) from the acquirer 104 and the received currency conversion rate (i.e., 1.10 USD per EUR in this example) (or, alternatively, the current currency conversion rate if appropriate). The conversion engine 116 employs the same logic, algorithm, routine, etc., as used at 308, to calculate the converted transaction amount, thereby ensuring that the clearing transaction amount is the same as the converted transaction amount, from 308, when the fixed currency conversion rate is employed. For example, the rounding logic of the calculation of the converted transaction amount is consistent with the rounding logic of the calculation of the clearing transaction amount. In addition, fees, mark-ups, or other issuer specific charges applied (e.g., via a cross-border fee manager (CBFM), etc.) are also determined in a consistent manner between the two converted transaction amounts. Once calculated, the conversion engine 116 passes, at 336, the transaction amount back to the clearing network 106b of the payment network 106. The clearing network 106b of the payment network 106 then clears, at 338, the transaction amount of the acquirer 104 and the issuer 108, whereby funds are designated to be transferred from the issuer 108 to the acquirer 104. When the transaction and multiple other transaction are finally “cleared,” the payment network 106 directs a fund transfer, as settlement, to account for the net position of the acquirer 104 and the issuer 108 (and other financial institutions, etc.).

In addition in the method 300, upon clearing the transaction amount for the given transaction, the clearing network 106b of the payment network 106 also notifies the acquirer 104 of the transaction amount, at 340, and notifies the issuer 108 of the transaction amount, at 342. The clearing network 106b of the payment network 106 also notifies the acquirer 104 of the acquirer financial position with the network (i.e., settlement amount) and the issuer 108 of the issuer financial position with the network (i.e., settlement amount) and the cardholder billing amount.

With that said, if the authorization network 106a of the payment network 106 determines, at 304, that currency conversion is not required (e.g., the transaction amount is already in the user's native currency, etc.), the authorization network 106a of the payment network 106 further determines, at 344, whether DCC has been performed. Specifically, for example, the authorization request may include data indicative of a DCC, such as, for example, an original transaction amount in the local/foreign currency, currency data (e.g., a currency code, a local currency indicator based on the merchant's location, an indicator of the user's native currency, etc.), the transaction amount as provided in the native currency of the user's account (at the DCC rate), and/or location data, etc. And, in connection therewith, the authorization network 106a may identify the transaction as being associated with DCC, based on the inclusion of the two amounts in different currencies (or through other suitable information included in the authorization request message (e.g., a DCC flag, etc.) or otherwise). When the authorization network 106a determines that the DCC was performed (e.g., by the merchant 102, etc.), in this example, it notifies the conversion engine 116 and the conversion engine 116 compiles, at 346, a notice message related to the DCC. The notice message may include, for example, the original amount of the transaction in the local/foreign currency, an implied currency conversion rate (e.g., based on the converted transaction amount (in the user's native currency) divided by the original currency amount), a current network currency conversion rate, and a difference between the transaction amount based on the network currency conversion rate and the DCC rate. Alternatively, in other implementations of the method 300, the authorization network 106a may compile the notice message (at 346) upon determining that DCC applies (instead of notifying the conversion engine 116).

As an example, in the above scenario where the user 110 initiated a purchase at the merchant 102 and the original transaction amount is €100, for a DCC from Euros to U.S. dollars and where the converted transaction amount is $125, the notice message may indicate that the network rate is 1.10 USD per EUR (as indicated above), that the transaction amount based on the network currency conversion rate is $110, and that a difference between the DCC converted transaction amount and the network converted transaction amount is $15.00 (i.e., indicating that the converted transaction amount based on the network currency conversion rate is less). With that said, the conversion engine 116 may include more or less information in the message related to the currency conversion in other instances, potentially, for example, as desired by the issuer 108.

As another example, the notice message may include an interval for which the network currency conversion rate is valid. This may include the interval until a next scheduled adjustment of the network currency conversion rate by the payment network 106, which may occur multiple times per day, daily, or at another interval. As such, in the above scenario where the user 110 initiated a purchase at the merchant 102 and the original transaction amount is €100, the network currency conversion rate may change daily, whereby the notice message may indicate the network currency conversion rate of 1.10 USD per EUR is valid until 11:59 pm (local time where the transaction is performed) or that the network currency conversion rate of 1.10 USD per EUR is valid for the next “X” number of hours, minutes, etc.

Once the notice message is compiled, it is transmitted, at 348, by the conversion engine 116 (or potentially by the authorization network 106a of the payment network 106 when the authorization network 106a makes the determination that DCC has been performed and does not notify the conversion engine 116 of the same) to the issuer 108. The issuer 108, in turn, transmits, at 350, the notice message to the user 110, at the communication device 112, in whole or in part (e.g., as a SMS message, an email, or a notice to a network-based application installed at the user's communication device 112, etc.). The notice message, then, may include the network currency conversion rate, the difference of the rates on the last transaction, and the valid interval of the rate (e.g., “The Network Currency Conversion Rate is 1.10 USD per EUR. You would have save $15 on your last transaction. The 1.10 USD per EUR rate is valid up until midnight,” etc.). In other examples, the notice to the user 110 may include more or less information, for example, as desired by the user 110 or the issuer 108, etc.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and without limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving, at a conversion engine computing device, via a payment network, a request for currency conversion associated with an authorization request for a transaction to a payment account, the request for currency conversion including a currency code for the transaction different than a currency code of a native currency of the payment account to which the transaction is directed; (b) identifying, by the conversion engine computing device, a currency conversion rate for the transaction based on a rate file stored in a rate file data structure, the currency conversion rate associated with a rate file identifier; (c) determining, by the conversion engine computing device, a converted transaction amount based on a transaction amount included in the authorization request and the currency conversion rate; (d) passing, by the conversion engine computing device, the converted transaction amount to an authorization network of the payment network, in response to the request for the currency conversion; (e) receiving, at the conversion engine computing device, a request for conversion in connection with clearing of the transaction, the request including the rate file identifier; (f) retrieving, by the conversion engine computing device, the currency conversion rate from the rate file data structure based on the rate file identifier, wherein the currency conversion rate is not based on a current currency conversion rate; (g) determining, by the conversion engine computing device, a clearing transaction amount based on the transaction amount as included in a clearing record and the currency conversion rate received from the rate file data structure, whereby the clearing transaction amount and the converted transaction amount are the same; (h) passing, by the conversion engine computing device, the clearing transaction amount to a clearing system of the payment network, thereby permitting the clearing system to clear and settle the transaction; (i) determining, by the authorization network, whether the transaction involves currency conversion based on the currency code for the transaction, prior to transmitting, by the authorization network, the authorization request to the conversion engine computing device; (j) appending a fee to the determined clearing transaction amount prior to passing the clearing transaction amount to the clearing system of the payment network; (k) receiving the authorization request at the authorization network, via a single message scheme of the payment network prior to providing the request for currency conversion associated with an authorization request to the conversion engine computing device; and (l) clearing of the transaction by the clearing system of the payment network, via a dual message scheme of the payment network.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in providing a fixed currency conversion rate for a transaction, the method comprising:
receiving, at a conversion engine computing device, via a payment network, a request for currency conversion associated with an authorization request for a transaction to a payment account, the request for currency conversion including a currency code for the transaction different than a currency code of a native currency of the payment account to which the transaction is directed;
identifying, by the conversion engine computing device, a currency conversion rate for the transaction based on a rate file stored in a rate file data structure, the currency conversion rate associated with a rate file identifier;
determining, by the conversion engine computing device, a converted transaction amount based on a transaction amount included in the authorization request and the currency conversion rate;
passing, by the conversion engine computing device, the converted transaction amount to an authorization network of the payment network, in response to the request for the currency conversion;
receiving, at the conversion engine computing device, a request for conversion in connection with clearing of the transaction, the request including the rate file identifier;
retrieving, by the conversion engine computing device, the currency conversion rate from the rate file data structure based on the rate file identifier, wherein the currency conversion rate is not based on a current currency conversion rate;
determining, by the conversion engine computing device, a clearing transaction amount based on the transaction amount as included in a clearing record and the currency conversion rate received from the rate file data structure, whereby the clearing transaction amount and the converted transaction amount are the same; and
passing, by the conversion engine computing device, the clearing transaction amount to a clearing system of the payment network, thereby permitting the clearing system to clear and settle the transaction.

2. The method of claim 1, further comprising determining, by the authorization network, whether the transaction involves currency conversion based on the currency code for the transaction, prior to transmitting, by the authorization network, the authorization request to the conversion engine computing device.

3. The method of claim 1, wherein the rate file identifier includes a time and date of the authorization request; and
wherein the currency conversion rate includes the currency conversion rate for which the reference time and date is consistent with the time and date of the authorization request.

4. The method of claim 3, wherein rate file identifier further includes an authorization identifier (ID) associated with the transaction.

5. The method of claim 1, wherein retrieving the currency conversion rate from the rate file data structure includes identifying the rate file identifier from a data file included in the rate file data structure based on a transaction type for the transaction and/or a merchant category code (MCC) for a merchant involved in the transaction.

6. The method of claim 1, wherein determining the clearing transaction amount is based on the received currency conversion rate when the request for conversion in connection with clearing of the transaction is within a time interval associated with the currency conversion rate; and
wherein determining the clearing transaction amount is based on a current currency conversion rate when the request for conversion in connection with clearing of the transaction is outside the time interval associated with the currency conversion rate.

7. The method of claim 1, wherein the rate file identifier includes at least one of an authorization identifier (ID) and a time and date associated with one of multiple authorization requests for said transaction.

8. The method of claim 1, further comprising appending a fee to the determined clearing transaction amount prior to passing the clearing transaction amount to the clearing system of the payment network.

9. The method of claim 1, further comprising:
receiving the authorization request at the authorization network, via a single message scheme of the payment network prior to providing the request for currency conversion associated with an authorization request to the conversion engine computing device; and
clearing of the transaction by the clearing system of the payment network, via a dual message scheme of the payment network.

10. A system for use in identifying currency conversion rates in connection with certain transactions, the system comprising:
a rate file data structure including multiple currency conversion rates, each currency conversion rate associated with a rate file identifier; and
a processor coupled to the memory and configured to:
receive, via a payment network, a request for currency conversion associated with an authorization request for a transaction to a payment account, the request for currency conversion including a transaction amount and a currency code for the transaction different than a currency code of a native currency of the payment account to which the transaction is directed;
store a currency conversion rate for the transaction in the rate file data structure, the currency conversion rate associated with a rate file identifier;
calculate a converted transaction amount based on the transaction amount and the currency conversion rate;
pass the converted transaction amount to an authorization network of the payment network, in response to the request for the currency conversion;
receive a request for conversion in connection with clearing of the transaction, the request including the rate file identifier;
retrieve the currency conversion rate from the rate file data structure based on the rate file identifier;
when the request for conversion in connection with clearing of the transaction is received within a time interval associated with the currency conversion rate, calculate a clearing transaction amount based on the received currency conversion rate, whereby the clearing transaction amount and the converted transaction amount are the same; and
pass the clearing transaction amount to a clearing system of the payment network, thereby permitting the clearing system to clear and settle the transaction.

11. The system of claim 10, wherein the rate file identifier includes a time and date of the transaction.

12. The system of claim 10, wherein the processor is further configured to identify the time interval based on a merchant category code (MCC) of a merchant involved in the transaction and/or a type of the transaction.

13. The system of claim 10, wherein the rate file identifier includes an authorization identifier (ID) associated with the transaction.

14. The system of claim 10, wherein the processor is further configured to:
compile a notice message when dynamic currency conversion (DCC) is associated with the transaction, the notice message including at least one of the currency conversion rate and a transaction amount based on the currency conversion rate; and
transmit the notice message of an issuer of the payment account.

15. The system of claim 10, further comprising the authorization network coupled in communication with the processor and configured to:
receive the authorization request; and
provide the request for currency conversion associated with the authorization request to the processor when the currency code for the transaction is different than the currency code of the native currency of the payment account.

16. The system of claim 10, wherein the processor is configured, in connection with retrieving the currency conversion rate from the rate file data structure, to identify the rate file identifier from a data file included in the rate file data structure based on a transaction type for the transaction and/or a merchant category code (MCC) for a merchant involved in the transaction.

17. A non-transitory computer-readable storage media including executable instructions for identifying currency conversion rates, which when executed by at least one processor, cause the at least one processor to:
receive, via a payment network, a request for currency conversion associated with an authorization request for a transaction to a payment account, the request for currency conversion including a transaction amount and a currency code for the transaction different than a currency code of a native currency of the payment account to which the transaction is directed;
store a currency conversion rate for the transaction in a rate file data structure, the currency conversion rate associated with a rate file identifier;
calculate a converted transaction amount based on the transaction amount and the currency conversion rate;
pass the converted transaction amount to an authorization network of the payment network, in response to the request for the currency conversion;
receive a request for conversion in connection with clearing of the transaction, the request including the rate file identifier;
retrieve the currency conversion rate from the rate file data structure based on the rate file identifier;
calculate a clearing transaction amount based on the retrieved currency conversion rate, whereby the clearing transaction amount and the converted transaction amount are the same; and
pass the clearing transaction amount to a clearing system of the payment network, thereby permitting the clearing system to clear and settle the transaction.

18. The non-transitory computer-readable storage media of claim 17, wherein the executable instructions, when executed by the at least one processor, further cause the at least one processor to:
determine whether the request for conversion in connection with clearing of the transaction is received within a time interval associated with the currency conversion rate; and
calculate the clearing transaction amount based on the received currency conversion rate when the request for conversion in connection with clearing of the transaction is received within the time interval.

19. The non-transitory computer-readable storage media of claim 18, wherein the executable instructions, when executed by the at least one processor, further cause the at least one processor to:
compile a notice message when dynamic currency conversion (DCC) is associated with the transaction, prior to receipt of the authorization request by the payment network, the notice message including at least one of the currency conversion rate and a transaction amount based on the currency conversion rate; and
transmit the notice message of an issuer of the payment account.

20. The non-transitory computer-readable storage media of claim 17, wherein the executable instructions, when executed by the at least one processor in connection with retrieving the currency conversion rate from the rate file data structure, further cause the at least one processor to identify the rate file identifier from a data file included in the rate file data structure based on a transaction type for the transaction and/or a merchant category code (MCC) for a merchant involved in the transaction.
